(19) United States
(12) Patent Application Publication
(10) Pub. No.: US 2023/0306480 A1
(43) Pub. Date: Sep. 28, 2023

(54) PAYMENT METHOD AND STORAGE MEDIUM STORING PROGRAM

(71) Applicant: ACCRETE, INC., Tokyo (JP)

(72) Inventors: Yusei TANAKA, Tokyo (JP); Keiichi KAMIKAWA, Tokyo (JP); Masaru YOSHIDA, Tokyo (JP)

(21) Appl. No.: 18/199,004

(22) Filed: May 18, 2023

Related U.S. Application Data
(63) Continuation of application No. PCT/JP2021/040148, filed on Oct. 29, 2021.

(30) Foreign Application Priority Data
Nov. 20, 2020 (JP) 2020-193908

(51) Int. Cl. G06Q 30/04; G06Q 20/10; G06Q 20/14; G06Q 20/38; G06Q 20/40

(52) U.S. Cl. CPC G06Q 30/04; G06Q 20/102; G06Q 20/14; G06Q 20/386; G06Q 20/4014

(57) ABSTRACT

To provide an environment in which intermediation of payment can be implemented while maintaining the certainty, information security, and the credibility of cashless payment such as credit card payment. The disclosed technology provides a method for intermediating a billing payment process for a trading partner of a customer from the customer, wherein a phone number uniquely allocated to the customer is prepared, comprising: receiving information about billing associated with first identification information for identifying the billing from a device managed by the customer; specifying a payment process from information including the first identification information and the billing information; and transmitting, to the device managed by the customer, a message for causing the payment process to be executed based on a comparison result between the first identification information and second identification information delivered in communication addressed to the phone number from a mobile terminal managed by the trading partner.

### CROSS-REFERENCE OF RELATED APPLICATIONS

This application is a continuation of International No. PCT/JP2021/040148, filed Oct. 29, 2021, which claims priority to Japanese Patent Application No. 2020-193908, filed Nov. 20, 2020. The contents of these applications are incorporated herein by reference in their entirety.

### TECHNICAL FIELD

The disclosure relates to a payment method and a storage medium storing a program.

### BACKGROUND ART

When payment methods not using cash, such as credit card payment and cashless payment, are used, it is important to prevent unauthorized use of credit card information and cashless payment information.

For example, it has been pointed out that when information such as a credit card number is stored in a store’s system, this stored information may lead to credit-card skimming or the like. For this reason, stores and the like avoid storing information such as credit card numbers in the store system, prepare a dedicated hardware device provided by a payment agent, and use this dedicated hardware to read a credit card for payment.

For example, there is a technology (see, for example, Patent Document 1) including: a step of generating a unique one-time digital code for identifying the transaction by a POS system (or by a customer’s mobile device); a step of transmitting transaction data together with the unique one-time digital code to an owner’s bank of the POS system through a first digital network path; a step of concurrently transmitting the unique one-time digital code and billing information issued by the mobile device to the bank through a second digital network path; and a step of merging transaction data from the POS system with the billing information issued by the mobile device by the bank (or by a payment system/transaction network) and settling the transaction when the merge is successful. The merge always succeeds when the codes match. Thus, the bank is notified that the transaction has been approved through different paths merged at the bank.

In another example, there is a technology (see, for example, Patent Document 2) related to an information management server that transmits a short message in SMS to a mobile terminal of a user based on a credit card payment request from the user. The information management server includes: an identification information acquisition unit that acquires the URL of a screen for entering payment information; an identification information adding unit that adds the URL acquired by the identification information acquisition unit to the short message; and a transmission unit that transmits the short message with the URL to the mobile terminal of the user. The information management server also includes a control unit that receives user information and information required for a service from an information terminal of a service provider, and combines the user information and the information required for the service to generate first information. Every time the user information and the information required for the service are received from the information terminal and the first information is generated, the control unit extracts a phone number of the mobile terminal from a personal information DB of the information terminal and transmits a short message to the mobile terminal, and displays the user information and the information required for the service on the screen.

In such conventional technologies, in order to protect confidential information of a trading partner and to confirm the identity of the trading partner, it has been required to prepare dedicated hardware or introduce an advanced system such as preparing a system for pre-storing information for confirming the identity of the trading partner in a database. For example, it has been necessary to prepare dedicated credit card processing equipment also when credit card payments and the like are handled in a small store or by sales staff on the go.

In addition, even for cashless payments other than by credit card, the trading partner has been required to perform advance preparations required to use the application so that a payment mechanism of the application can be used by having a dedicated application preinstalled on their mobile terminal to have their credit card pre-registered, or presetting money charging or auto charging.

Also, for example, when a message requesting payment of money is suddenly sent by SMS, email or the like, the user may have doubts about the reliability of the message.

### PRIOR ART DOCUMENT

### Patent Document

Patent Document 1: Japanese Patent No. 6085037
Patent Document 2: Japanese Patent No. 6431377

### SUMMARY

### Problem to Be Solved

It is an object of the disclosed technology to provide an environment in which intermediation of payment can be implemented while maintaining the security, integrity, and credibility of cashless payment such as credit card payment.

The disclosed technology provides a method for intermediating a billing payment process for a trading partner of a customer from the customer, wherein a phone number uniquely allocated to the customer is prepared, comprising: receiving information about billing associated with first identification information for identifying the billing from a device managed by the customer; specifying a payment process from information including the first identification information and the billing information; and transmitting, to the device managed by the customer, a message for causing the payment process to be executed based on a comparison result between the first identification information and second identification information delivered in communication addressed to the phone number from a mobile terminal managed by the trading partner.

The disclosed technology also provides a non-transitory storage medium storing a program for causing a computer to execute the above method.

### Advantageous Effects

According to the disclosed technology, it is possible to provide an environment in which intermediation of payment can be implemented while maintaining the security, integrity, and credibility of cashless payment such as credit card payment.

### BRIEF DESCRIPTION OF THE DRAWINGS

FIG. 1A shows a procedure for allocating a unique phone number to a customer. FIG. 1B is a diagram schematically showing sequences of intermediation of payment between the business operator’s device and other devices.

FIG. 2A is a diagram showing an outline of information exchange among the devices. FIG. 2B is a diagram showing a hardware configuration of the business operator’s device.

FIG. 3 is a flowchart schematically showing a payment service generation processing flow in the business operator’s device.

FIG. 4 is a flowchart schematically showing an incoming call processing flow in the business operator’s device.

FIG. 5 is a flowchart schematically showing an entry invalidation process of the trading partner’s mobile terminal management table.

FIG. 6 is a flowchart showing an outline flow of a message transmission process to the trading partner’s mobile terminal, which is performed by the business operator’s device.

FIG. 7 is a functional block diagram of the business operator’s device.

FIG. 8 is a diagram showing an example of a display screen displayed on the customer device by the business operator’s device and a display screen displayed on the trading partner’s mobile terminal by the business operator’s device.

FIG. 9 is a diagram showing an example of a display screen displayed on the customer device by the business operator’s device and a display screen displayed on the trading partner’s mobile terminal by the business operator’s device.

FIG. 10 is a diagram showing an example of a display screen displayed on the customer device by the business operator’s device and a display screen displayed on the trading partner’s mobile terminal by the business operator’s device.

FIG. 11 is a diagram showing an example of a display screen displayed on the customer device by the business operator’s device and a display screen displayed on the trading partner’s mobile terminal by the business operator’s device.

FIG. 12 is a diagram showing an example of a display screen displayed on the customer device by the business operator’s device and a display screen displayed on the trading partner’s mobile terminal by the business operator’s device.

FIGS. 13A and 13B are diagrams showing examples of a display screen displayed on the customer device by the business operator’s device and a display screen displayed on the trading partner’s mobile terminal by the business operator’s device;

FIG. 13C is an example of an unauthorized screen displayed on the trading partner’s mobile terminal.

FIG. 14 is a diagram showing an example of the phone number allocation table for managing receiver’s phone numbers pre-allocated to each customer.

FIG. 15 is a diagram showing an example of a payment service management table.

FIG. 16 is a diagram showing an example of a trading partner’s mobile terminal management table.

### DETAILED DESCRIPTION

Embodiments will be described below with reference to the drawings.

The following terms are used in this specification.

A business operator is someone who acts as an intermediary for payment based on an agreement made between a customer of the business operator and a trading partner of the customer. The business operator is a company that intervenes between the customer and a company (payment agent), such as a credit card company, that substantially executes a cashless payment and requests the payment agent to make a payment.

The customer and the business operator do not handle information that is required to be kept secret and not desirable for security purposes to be handled by anyone other than a specific person during payment, such as a credit card number managed by the customer’s trading partner and cashless payment information.

The payment service business operator can handle information that is required to be kept secret and not desirable for security purposes to be handled by anyone other than a specific person during payment, such as the trading partner’s credit card information or cashless payment information.

A device under the control of the customer is referred to as a customer device, a device under the control of the trading partner is referred to as a trading partner’s mobile terminal, a device under the control of the business operator is referred to as a business operator’s device, and a device under the control of the payment agent is referred to as a payment agent’s device.

Steps of a method according to the embodiment described below may be performed in any order as long as there is no discrepancy. Also, a plurality of steps may be performed simultaneously. Each step may be implemented by executing a program stored in a memory. Each step may also be partially implemented by an operating system or hardware. Not all steps need to be executed, and execution of certain steps may be omitted. One step may be performed more than once, and a plurality of steps may be performed repeatedly. The steps are not exclusive and can be combined as long as there is no discrepancy.

A program that causes a computer to execute the disclosed method can be stored in a non-transitory storage medium. Examples of a non-transitory memory include but are not limited to RAM, ROM, USB memory, DVD, and the like. Apart of the program may be executed in a re-entrant manner. The program may be executed substantially simultaneously by a plurality of independently processed tasks corresponding to each of a plurality of processing targets.

Each embodiment may also be implemented as a hardware device.

More specifically, it goes without saying that a technology that executes the method or program in a different order from that described in the claims or a technology that executes part of the processing simultaneously also belongs to the technical scope of the subject matter defined in the claims.

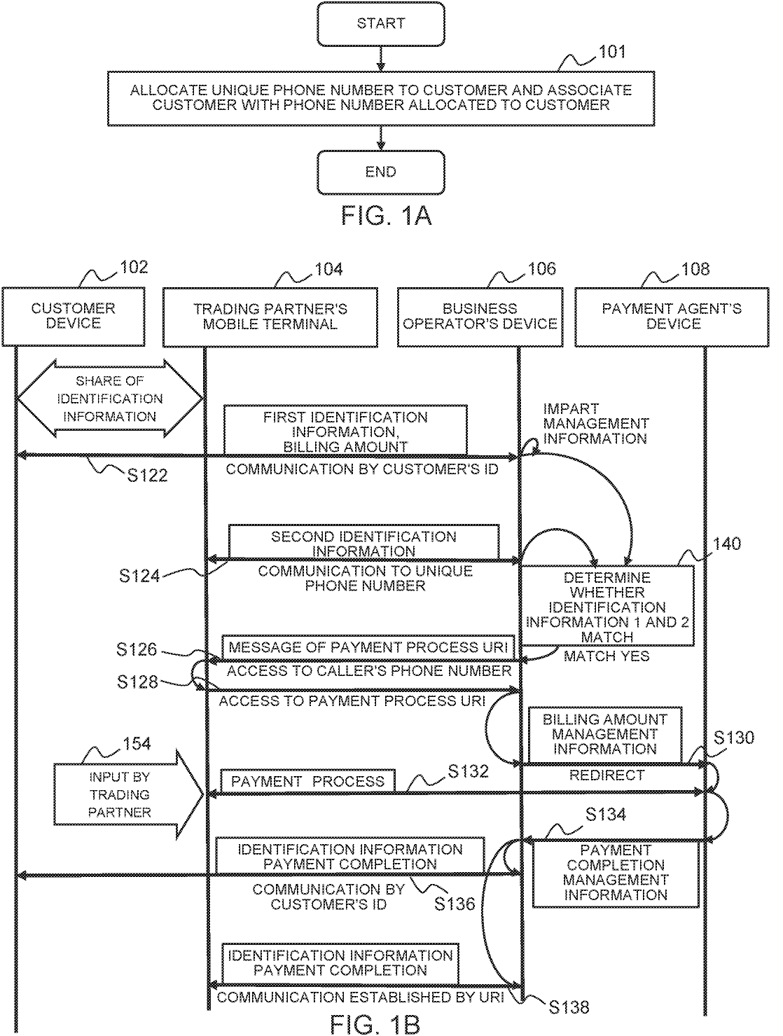

FIG. 1A shows a procedure for allocating a unique phone number to a customer. A business operator allocates unique phone numbers to their customers.

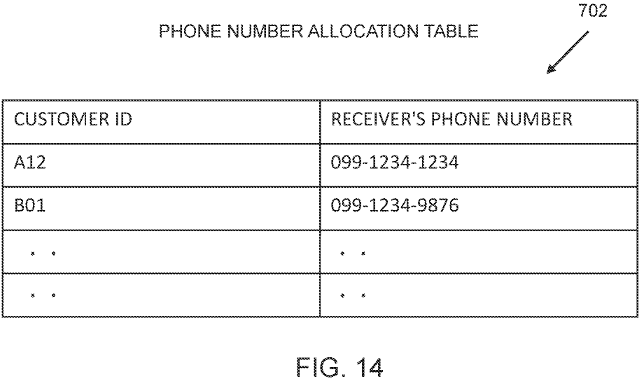

The phone number is used as follows. For example, a customer is associated with a phone number allocated to the customer, which is stored in a phone number allocation table (FIG. 14) in a storage unit of a device managed by the business operator. FIG. 14 shows a specific example of the phone number allocation table.

The customer communicates the phone number uniquely allocated to the customer to a trading partner of the customer. Then, the trading partner uses a trading partner’s mobile terminal 104 managed by the trading partner to make a call to the phone number uniquely allocated to the customer. Thus, a business operator’s device 106 can know with which customer a trading is carried out by the trading partner who operates the trading partner’s mobile terminal 104. The call may be a voice call or may be a message communication or the like addressed to a phone number.

More specifically, the business operator searches through the phone number allocation table described above for a phone number (receiver’s phone number) of an incoming call, and thus can specify with which customer the trading is carried out by the trading partner who manages the trading partner’s mobile terminal 104.

In addition, the business operator can know the phone number of the trading partner’s mobile terminal 104 managed by the trading partner from a caller’s phone number of the incoming call. Therefore, the business operator’s device 106 can realize reliable information exchange with the trading partner’s mobile terminal 104 by communicating with the caller’s phone number.

As for the phone number to be allocated, one phone number may be allocated to each customer, or a different phone number may be allocated to each customer’s branch office (or each sales representative or the like). When a different phone number is allocated to each customer’s branch office (or each sales representative or the like), it is possible to know with which customer’s branch office (or each sales representative or the like) the trading is carried out by the trading partner who manages the trading partner’s mobile terminal 104.

FIG. 1B is a diagram schematically showing sequences of intermediation of payment between the business operator’s device 106 and other devices. Since FIG. 1B schematically shows the sequences, other sequences may be interposed between vertically adjacent sequences. The order of the sequences may be changed as long as there is no discrepancy. Alternatively, one sequence may include a plurality of bi-directional information transmission sequences to be executed in chronological order.

In the embodiments described below, it is assumed that a customer and a trading partner of the customer make an agreement and the customer charges (bills) the trading partner a predetermined amount of money. A billing payment process is called a payment service. The trading partner’s mobile terminal 104 and a payment agent’s device 108 can exchange confidential information used for payment services such as credit card payment and cashless payment.

Such confidential information is not sent to the customer device 102 or the business operator’s device 106. Thus, leakage of confidential information used for payment services such as credit card payment or cashless payment can be prevented.

In FIG. 1B, sequences of processes in the customer device 102 managed by the customer, the trading partner’s mobile terminal 104 managed by the trading partner of the customer, the business operator’s device 106 managed by the business operator, and the payment agent’s device 108 managed by the payment agent are listed from top to bottom in chronological order.

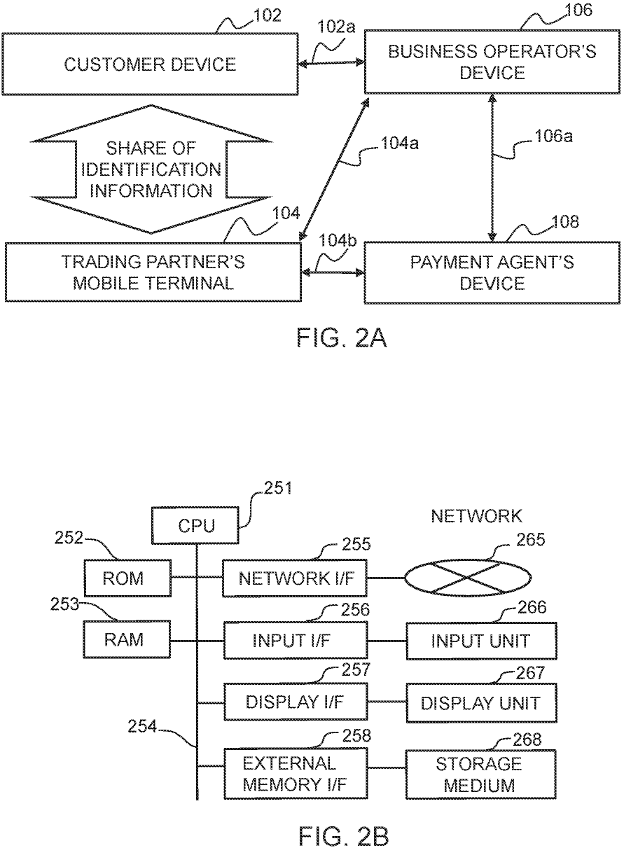

FIG. 2A is a diagram showing an outline of information exchange among the devices. The customer device 102 and the trading partner’s mobile terminal 104 may electronically exchange information via a network such as the Internet, near field communication such as Bluetooth (registered trademark), or optical communication (for example, communication between a QR code (registered trademark) or the like displayed on a screen, a paper medium or the like and an optical reader such as a camera that captures the QR code (registered trademark) ) . Note that transmission of identification information and the like and share of such information between the customer device 102 and the trading partner’s mobile terminal 104 may be realized by sharing through electronic information exchange as described above or by receiving key input or the like by either or both of operators of the customer device 102 and the trading partner’s mobile terminal 104. In the latter case, the share of identification information can be realized without using any electronic information exchange mechanism such as networks (oral communication, key input of information written on a paper medium, and the like).

The customer device 102 and the business operator’s device 106 are connected through a communication path 102a. The trading partner’s mobile terminal 104 and the business operator’s device 106 are connected through a communication path 104a. The trading partner’s mobile terminal 104 and the payment agent’s device 108 are connected through a communication path 104b.

It is desirable that general-purpose communication software such as a browser for browsing a website managed by the business operator’s device 106 is installed in the customer device 102 and the trading partner’s mobile terminal 104. Therefore, the customer device 102 and the trading partner’s mobile terminal 104 are not necessarily required to have dedicated hardware prepared or to have dedicated software installed, other than a general-purpose browser, for connecting to the business operator’s device 106.

Accordingly, the customer device 102 and the trading partner’s mobile terminal 104 can be realized by devices such as general-purpose PCs or mobile terminals installed with browser software having general security functions. Therefore, the customer device 102 and the trading partner’s mobile terminal 104 can save the trouble of preparing dedicated hardware or pre-installing dedicated software for information exchange with the business operator’s device 106.

It should be noted that this embodiment does not exclude the preparation of predetermined hardware or pre-installation of predetermined software.

Communication 106a between the business operator’s device 106 and the payment agent’s device 108 is desirably connected by a predetermined secure communication method. Information including billing information from the customer to the trading partner and management information regarding the billing is transmitted from the business operator’s device 106 to the payment agent’s device 108. Then, the payment agent’s device 108 reports a payment result corresponding to the management information, for example, to the business operator’s device 106.

Communication 104b between the trading partner’s mobile terminal 104 and the payment agent’s device 108 is connected by a connection method predetermined by the payment agent, and confidential information required for payment such as credit card numbers can be transmitted. Secure communication 104b between the trading partner’s mobile terminal 104 and the payment agent’s device 108 is communication that does not involve the customer device 102 and the business operator’s device 106. Therefore, the customer device 102 and the business operator’s device 106 do not need to handle confidential information in payment, such as credit card information or cashless payment information. Therefore, the trading partner’s mobile terminal 104 can secretly and safely exchange confidential information required for payment such as credit card information with the payment agent’s device 108. The payment result is also transmitted from the payment agent’s device 108 to the trading partner’s mobile terminal 104.

Referring back to FIG. 1B, the customer device 102 and the trading partner’s mobile terminal 104 share identification information. The identification information is information used by the business operator’s device 106 to identify the payment service for which the customer charges the trading partner based on the agreement between the customer and the trading partner.

As already mentioned, the customer device 102 and the business operator’s device 106 are connected through the communication path 102a. Likewise, the trading partner’s mobile terminal 104 and the business operator’s device 106 are connected through the communication path 104a. That is, the business operator’s device 106 can use the identification information handled by the customer device 102 and the identification information handled by the trading partner’s mobile terminal 104 to associate the same payment service in separate communications over the communication paths 102a and 104a.

In this specification, the identification information handled by the customer device 102 may be referred to as first identification information. Also, the identification information handled by the trading partner’s mobile terminal 104 may be referred to as second identification information. When the first identification information and the second identification information match, it can be seen that the payment service handled by the customer device 102 is the same as the payment service handled by the trading partner’s mobile terminal 104 (or that the both are very likely to be the same payment service). Here, “very likely to be the same payment service” means that the possibility is not zero that a payment service A handled by the customer device 102 and a payment service B handled by the trading partner’s mobile terminal 104 might be unintentionally associated as the same payment service.

Such an unintentional event may occur due to some human error, fraudulent act, communication error, intentional online attack, coincidence of identification information, and the like. Therefore, it is important to ensure the certainty to detect and prevent such unintentional events before they occur. As for the selection of variations of the embodiment from the viewpoint of ensuring such certainty, it is desirable to make the selection from multiple viewpoints such as the viewpoint of whether or not this embodiment is easy for users to use, the viewpoint of preventing phishing, the viewpoint of preventing the spread of spam messages, and the viewpoint of preventing site attacks from unauthorized persons. This will be described in detail along with variations in configuration of each embodiment.

The sequence of FIG. 1B will be described below as an example.

It is assumed that an operator of the customer device 102 and a trading partner conclude an agreement and the customer charges the trading partner. In this case, description is given below of an example of a sequence to complete a payment service between the trading partner’s mobile terminal 104 and the payment agent’s device 108 without the customer device 102 and the business operator’s device 106 being involved with confidential information such as credit card payment and cashless payment.

In the following example, first, description is given of an example where the last four digits of a mobile phone number of the trading partner’s mobile terminal 104 are used as identification information. The identification information is not limited to the last four digits of the mobile phone number, and other identification information may be used in consideration of the certainty as described above.

For example, when the entire phone number of the trading partner’s mobile terminal 104 is used as the identification information, the trading partner informs the customer who operates the customer device of the entire phone number of the trading partner’s mobile terminal 104. In an embodiment in which it is not appropriate to use the entire mobile phone number as the identification information, assuming that the trading partner may not want to disclose the phone number to the customer (for example, when the mobile phone number is to be kept confidential), it is desirable to use part of the phone number (for example, the last four digits of the mobile phone number of the trading partner’s mobile terminal 104) as the identification information. In this case, when calls are received from a plurality of trading partner’s mobile terminals 104 whose phone numbers partially match, it is necessary to carry out a process for preventing a situation where the payment service from the customer device 102 cannot be associated with the appropriate trading partner’s mobile terminal 104 with the identification information. This process will be described later.

Further, other examples of the identification information will be described later in modified examples of the configuration of the embodiment.

It is assumed that the customer device 102 is securely connected to the business operator’s device 106 using a login ID, a password, and the like. Therefore, upon receiving information from the customer device 102, the business operator’s device 106 can identify from which customer device 102 the information is transmitted. The business operator’s device 106 can also send appropriate information to the appropriate customer device 102.

The customer who operates the customer device 102 can receive the last four digits of the mobile phone number of the trading partner’s mobile terminal 104, which are transmitted orally, on a paper medium, by screen display or the like, from the trading partner who operates the trading partner’s mobile terminal 104. (Note that the transmission of the last four digits of the mobile phone is not limited thereto and may be transmitted through various kinds of communication or by reading an image such as a QR code (registered trademark).)

In sequence S122, the operator of the customer device 102 inputs the transmitted last four digits into the customer device 102, inputs a billing amount, and transmits the last four digits of the identification information and the billing amount to the business operator’s device 106.

It is desirable that the business operator’s device 106 imparts management information unique to an individual payment service so as to allocate this payment service to the billing amount and the customer device 102 information transmitted in sequence S122. This management information makes it possible to identify the payment service. Thus, the payment service can be specified by the management information and subsequent processes can be performed.

It is also desirable that the management information is transmitted from the business operator’s device 106 to the customer device 102 in sequence S122. By specifying the management information, the operator of the customer device 102 can specify a payment service related to billing handled by the business operator’s device 106.

In sequence S124, the trading partner’s mobile terminal 104 can transmit the last four digits of the phone number of the trading partner’s mobile terminal 104, which is second identification information, to the business operator’s device 106 by making communication (for example, making a call) addressed to a phone number uniquely allocated to the customer. This communication may be a voice call, message communication, or the like.

The phone number (receiver’s phone number) uniquely allocated to the customer can be orally communicated from the customer to the trading partner, or the phone number can be transmitted to the trading partner by showing the phone number to the trading partner through a medium such as paper or the screen of the customer device 102. Alternatively, the receiver’s phone number may be transmitted to the trading partner’s mobile terminal 104 by having the trading partner’s mobile terminal 104 read the QR code (registered trademark) containing the receiver’s phone number information. Alternatively, the receiver’s phone number may be transmitted to the trading partner’s mobile terminal 104 through near field communication such as the Internet or Bluetooth (registered trademark). The trading partner may use the trading partner’s mobile terminal 104 to make a call to the receiver’s phone number by voice call or message such as SMS.

Note that the phone number is composed of digits. Therefore, there is an advantage that the transmitted information is less likely to have an error even when transmitted orally or through a paper medium compared to an address such as an e-mail address that includes characters such as alphabets other than digits. Upon receiving a voice call or a message communication from the trading partner’s mobile terminal 104, the business operator’s device 106 can extract the caller’s phone number to know the last four digits of the phone number that is the identification information. Therefore, when the last four digits of the phone number, which is part of the caller’s phone number of the trading partner’s mobile terminal 104, are used as the identification information, the trading partner does not have to enter the identification information into the trading partner’s mobile terminal 104. This applies when part or all of the caller’s phone number of the trading partner’s mobile terminal 104 is used as the identification information.

When the last four digits of the phone number of the trading partner’s mobile terminal 104 are used as the identification information, there is a possibility that the same number may be used in multiple payment services, or that the last four digits of the caller’s phone numbers of a plurality of trading partner’s mobile terminals match. That is, there is a possibility that the last four digits of phone numbers of a plurality of trading partner’s mobile terminals 104 for the customer coincidentally match. Therefore, more digits than the last four digits of the phone number of the trading partner’s mobile terminal 104 or all digits may be used as the identification information.

Since the mobile phone number is a number uniquely allocated to a mobile phone, it is possible to uniquely specify a payment service by using all the digits of the trading partner’s mobile terminal 104 as the identification information. In this case, it is assumed that the customer and the trading partner do not use multiple payment services at the same time. Generally, it is virtually impossible that multiple payment services are used simultaneously by the same trading partner when making a purchase or receiving a service (that multiple separate billing events occur from the customer to the trading partner). When all digits of the mobile phone number are used as the identification information, the payment service can be uniquely specified.

Note that there is a possibility that a plurality of pieces of first identification information and a plurality of pieces of second identification information match each other. In this case, the business operator’s device 106 may send information to at least one of the customer device 102 and the trading partner’s mobile terminal 104 to prompt the trading partner’s mobile terminal 104 to send management information that uniquely specifies a payment service, for example, to the business operator’s device 106.

Note that when the management information is not sent from the trading partner’s mobile terminal 104 to the business operator’s device 106 or when other exceptional events occur, such as an input error, a transmission error, or when a wrong number addressed to the receiver’s phone number is received from a third party, it may not be possible to specify the same payment service due to matching of identification information. A method for coping with such a case (ensuring the certainty) will be described later.

In process 140, the business operator’s device 106 compares the first identification information with the second identification information. For example, when one phone number is allocated to a customer and multiple payment services do not occur concurrently for the customer, as long as the business operator’s device 106 confirms that the first identification information matches the second identification information through comparison, it may be determined that the information from the customer device 102 and the information from the trading partner’s mobile terminal 104, which are confirmed to match each other, are the information of the same payment service.

In process 140, when the identification information 1 and the identification information 2 do not match, there is a possibility that the information sent from either the customer device 102 or the trading partner’s mobile terminal 104 is late in reaching the business operator’s device 106. Therefore, it is desirable to repeat confirmation of matching between the identification information 1 and the identification information 2 within a certain period of time. When the identification information 1 and the identification information 2 do not match even after the certain period of time has passed, the business operator’s device 106 may notify the customer device 102 that the corresponding trading partner’s mobile terminal 104 cannot be specified for the relevant payment service. Alternatively, in this case, the business operator’s device 106 may cancel the relevant payment service and notify the customer device 102 that the payment service has been cancelled.

The reasons for such an event to occur include that the trading partner’s mobile terminal 104 makes a call to a phone number other than the phone number uniquely allocated to the customer, that the first identification information and the second identification information, which have reached the business operator’s device 106, are different due to a human error or transmission error, and the like.

In sequence S126, a message such as SMS containing information on URI that handles the payment service process for which the matching is confirmed in process 140 is sent to the caller’s phone number of the trading partner’s mobile terminal 104. The URI is an Internet address (URL) where a payment service is processed by a payment agent, access information required for the payment agent to carry out the payment service process, a command to be executed by the trading partner’s mobile terminal 104 set with a predetermined API, information for the trading partner’s mobile terminal 104 to shift to the execution of a program handling the payment service, and the like. Note that the message is not limited to SMS, and may be RCS, MMS, or the like. Alternatively, the message may be a message or the like in communication associated with SNS or the like.

By sending a message to the caller’s phone number in sequence S124 only when the matching between the first identification information and the second identification information is detected, a situation can be avoided where the message for payment is sent by mistake to the caller’s phone number of an accidental incoming call or to the caller’s phone number of a deliberate call for the purpose of attack or the like (or such a situation can be sufficiently prevented).

It is also possible to avoid sending messages (for example, spam messages) to unintended addresses by returning messages to the caller’s phone number (or the source of the communication using the address based on the phone number). It is also possible to respond to communication using phone numbers or communications using addresses based on the phone numbers, and to avoid returning a message to a communication whose source is spoofed by avoiding responding to normal e-mails and the like. Also, it is possible to avoid a DOS attack by mass e-mail or the like. Thus, it is possible to avoid disadvantages such as impairing the reliability of the embodiment.

In sequence S128, the trading partner’s mobile terminal 104 starts communication based on the URI. This communication allows the trading partner’s mobile terminal 104 to proceed with a payment procedure for an appropriate payment service.

The business operator’s device 106 may receive a connection request accessed based on the URI from the trading partner’s mobile terminal 104.

In sequence S130, the business operator’s device 106 may redirect the communication from the trading partner’s mobile terminal 104 to the payment agent’s device 108 along with information including billing information and management information that specifies the payment service.

In sequence S132, the trading partner’s mobile terminal 104 and the payment agent’s device 108 can directly exchange information on the payment service. Thus, the trading partner’s mobile terminal 104 and the payment agent’s device 108 can directly exchange information to be kept confidential in payment, such as credit card information or cashless payment information. Thus, it is possible to prevent information to be kept confidential from being leaked to a third party.

In this payment service process, the trading partner’s mobile terminal 104 can receive information required for payment from the trading partner (154) and communicate the information to the payment agent’s device 108. When the payment service is completed, the payment agent’s device 108 may notify the trading partner’s mobile terminal 104 of the completion of the service. On the other hand, when the payment process is not completed, the payment agent’s device 108 may notify the trading partner’s mobile terminal 104 of the non-completion of the process.

In sequence S134, when the payment service is completed, the payment agent’s device 108 may notify the business operator’s device 106 of the completion of the service together with the management information. On the other hand, when the payment process is not completed, the payment agent’s device 108 may notify the business operator’s device 106 of the non-completion of the process together with the management information.

In sequence S136, when the payment service is completed, the business operator’s device 106 may notify the customer device 102 of the completion of the service. On the other hand, when the payment process is not completed, the business operator’s device 106 may notify the customer device 102 of the non-completion of the process.

In sequence S138, when the payment service is completed, the business operator’s device 106 may notify the trading partner’s mobile terminal 104 of the completion of the service. On the other hand, when the payment process is not completed, the business operator’s device 106 may notify the trading partner’s mobile terminal 104 of the non-completion of the process.

### Summary of Embodiment

As described above, in the above embodiment, the customer device 102 and the business operator’s device 106 can process the payment service, for which the trading partner is charged by the customer, without touching confidential information such as credit card information or confidential information regarding cashless payment exchanged between the trading partner’s mobile terminal 104 and the payment agent’s device 108.

Here, a supplementary description is given of the reason for using two different communication paths, the communication path 102a and the communication path 104a, as described above.

First, the customer device 102 sends information including billing information and the first identification information to the business operator’s device 106 through the communication path 102a. The trading partner’s mobile terminal 104 sends information including the caller’s phone number of the trading partner’s mobile terminal 104 and the second identification information to the business operator’s device 106 through the communication path 104a.

Once the trading partner’s mobile terminal 104 starts communicating with the phone number allocated to the customer, the business operator’s device 106 can know which customer the trading partner’s mobile terminal 104 is associated with.

The business operator’s device 106 can associate the payment service of the customer device 102 with the trading partner’s mobile terminal 104 by confirming that the first identification information and the second identification information match.

The business operator’s device 106 sends a URI for processing the associated payment service to the trading partner’s mobile terminal 104.

Based on the URI received, the trading partner’s mobile terminal 104 can directly access the payment agent’s device 108 by redirecting or the like via the business operator’s device 106. In this event, the business operator’s device 106 gives billing information and management information for specifying the payment service to the payment agent’s device 108.

As described above, the trading partner’s mobile terminal 104 can exchange credit card information or the like for processing the payment service or confidential information such as cashless payment by communicating directly with the payment agent’s device 108 without the knowledge of the customer device 102 and the business operator’s device 106. By using the communication paths 102a and 104a, the customer device 102 and the business operator’s device 106 can easily process the payment service while avoiding the leakage of confidential information handled by the trading partner’s mobile terminal 104 and the payment agent’s device 108.

When the payment is completed, the payment agent’s device 108 notifies the business operator’s device 106 of the payment result of the payment service. The customer device 102 or the trading partner’s mobile terminal 104 can receive the payment result from the business operator’s device 106.

The above is a comprehensive description of the processing of the embodiment.

In the above embodiment, part or all of the phone number of the trading partner’s mobile terminal 104 is used as the identification information. One of the functions of the identification information is to associate payment services sent through the communication paths 102a and 104a, since the same payment service information is transmitted through the both paths. In order to ensure this function, it is also possible to use other information as the identification information aside from or in addition to the phone number information of the trading partner’s mobile terminal 104. Alternatively, a plurality of pieces of information can also be combined and used as the identification information.

Examples of information that can be used as the identification information will be described later.

One of the common effects associated with the transmission of a message containing the URI for the payment service process from the business operator’s device 106 to the trading partner’s mobile terminal 104 only when the first identification information from the customer device 102 and the second identification information from the trading partner’s mobile terminal 104 match is that the message containing the URI for the payment service process from being transmitted from the business operator’s device 106 to a wrong address. Alternatively, the probability of sending a message to a wrong address can be reduced to near zero. When such a message containing the URI for the payment service process is sent to a wrong address, the message will cause unnecessary confusion to a person who manages a mobile terminal that has received the message. To prevent (or reduce) the occurrence of such a situation, it is desirable that the business operator’s device 106 sends the message containing the URI for the payment service process to the trading partner’s mobile terminal 104 when the first identification information from the customer device 102 and the second identification information from the trading partner’s mobile terminal 104 match. Note that what to do when a message containing the URI for the payment service process is sent to a wrong address will be described later.

FIG. 2B is a diagram showing a hardware configuration of the business operator’s device 106. The business operator’s device 106 includes a CPU 251, a ROM 252, a RAM 253, a network interface 255, an input interface 256, a display interface 257, and an external memory interface 258.

A network 265 is connected to the network interface 255. The customer device 102, the trading partner’s mobile terminal 104, the payment agent’s device 108, and the like are connected to the network 265. An input device such as a touch sensor, a camera, and a microphone may be connected to the input interface 256. An output device such as a display unit 267 may be connected to the display interface 257. A storage medium 268 is connected to the external memory interface 258. A computer program implementing the embodiment disclosed in the specification and drawings may be stored in the storage medium 268 that is a tangible, non-transitory memory, the ROM 252 or the RAM 253. This computer program is executed by the CPU 251.

The computer program can also be downloaded through the network 265. These hardware components are connected to each other by a bus 254.

The hardware configuration of the business operator’s device 106 shown in FIG. 2B is merely an example, and any other hardware may be applied.

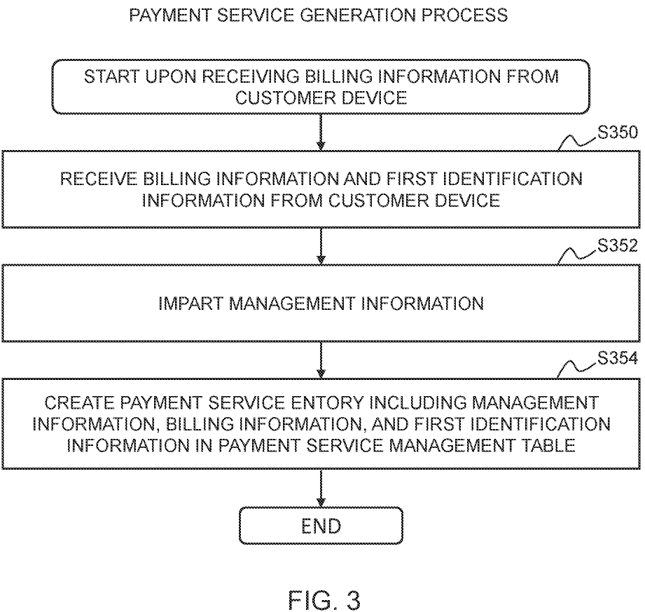

FIG. 3 is a flowchart schematically showing a payment service generation processing flow in the business operator’s device 106. Each processing step will be described in order.

The following processing is preferably started in the business operator’s device 106 when billing information is received from the customer device 102.

[Step S350] The business operator’s device 106 receives the billing information and the first identification information from the customer device.

[Step S352] The business operator’s device 106 imparts unique management information to the billing information and the first identification information from the customer device. With this management information, the payment service can be identified.

[Step S354] The business operator’s device 106 creates an entry for a payment service including the management information, the billing information, and the first identification information in a payment service management table.

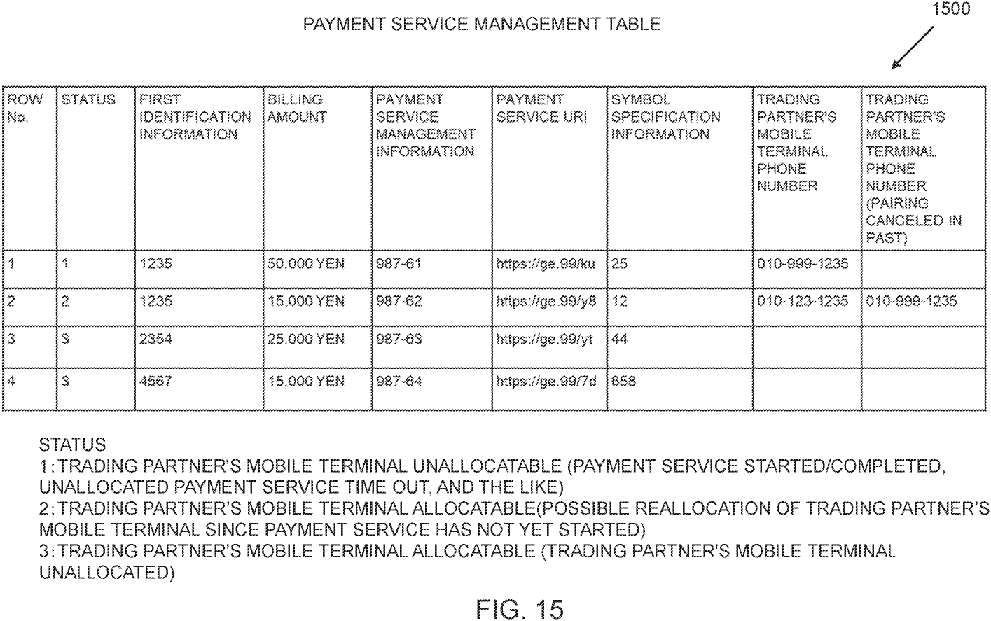

FIG. 15 shows an example of a payment service management table 1500. The payment service management table 1500 shown in FIG. 15 will be described in detail later.

As described above, the business operator’s device 106 can manage the payment service by creating the payment service management table 1500. It goes without saying that it is not essential to manage the payment service using the payment service management table 1500 as shown in FIG. 15, and that other management methods may be used.

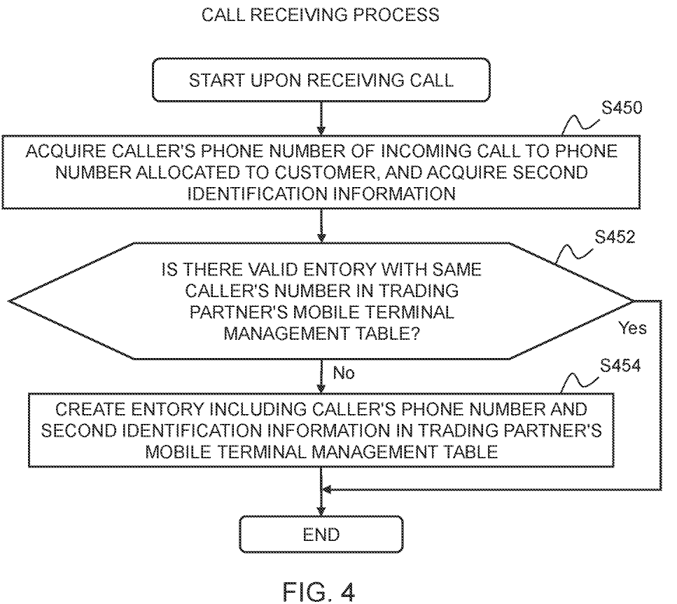

FIG. 4 is a flowchart schematically showing an incoming call processing flow in the business operator’s device 106.

The following processing is preferably started in the business operator’s device 106 when there is an even of an incoming call from the trading partner’s mobile terminal 104 to the phone number allocated to the customer. Note that the event is not limited to the incoming call, and may be an event such as an incoming message addressed to a phone number.

[Step S450] The business operator’s device 106 acquires a caller’s phone number and second identification information of the incoming call to the phone number allocated to the customer. As already mentioned, the caller’s phone number may include the second identification information.

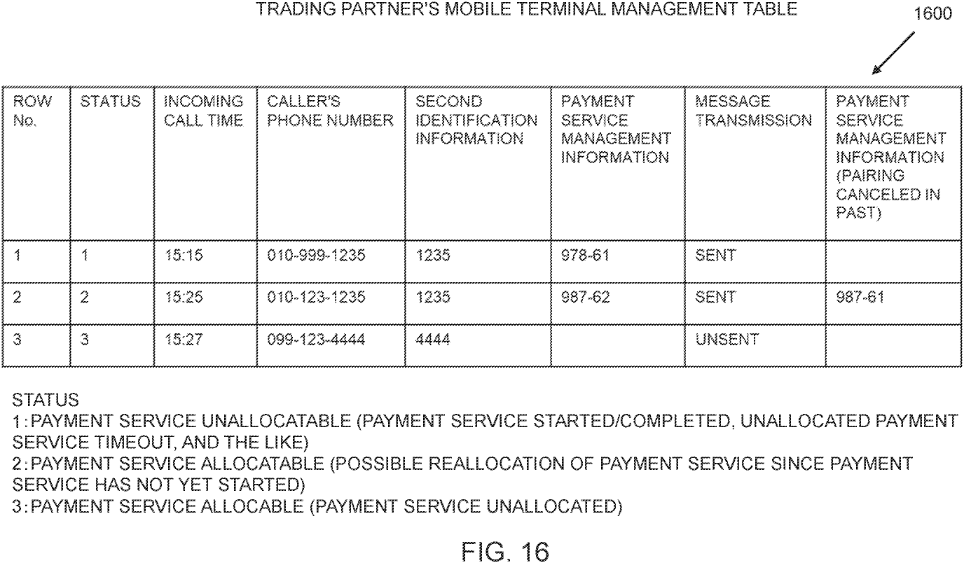

FIG. 16 shows an example of a trading partner’s mobile terminal management table 1600. It is preferable that the trading partner’s mobile terminal management table 1600 is created for each phone number allocated to the customer. The trading partner’s mobile terminal management table 1600 stores the caller’s phone number, the second identification information, and the like, which are obtained from the incoming call to the phone number allocated to the customer. The trading partner’s mobile terminal management table 1600 shown in FIG. 16 will be described in detail later.

Referring back to FIG. 4.

[Step S452] The business operator’s device 106 checks if a valid entry with the same caller’s number exists in the trading partner’s mobile terminal management table 1600. When the check result is affirmative (Yes), process 140 ends. When the check result is negative (No), the process moves to step S454.

This process makes it possible to avoid redundantly storing duplicate valid entries in the trading partner’s mobile terminal management table 1600.

[Step S454] The business operator’s device 106 creates an entry including the caller’s phone number and the second identification information in the trading partner’s mobile terminal management table 1600.

The above process makes it possible for the business operator’s device 106 to store, in the trading partner’s mobile terminal management table 1600, an entry containing the caller’s phone number and the second identification information obtained from the incoming call addressed to the phone number allocated to the customer from the trading partner’s mobile terminal 104. It goes without saying that the information including the caller’s phone number and the second identification information may be managed by other management methods without using the trading partner’s mobile terminal management table 1600.

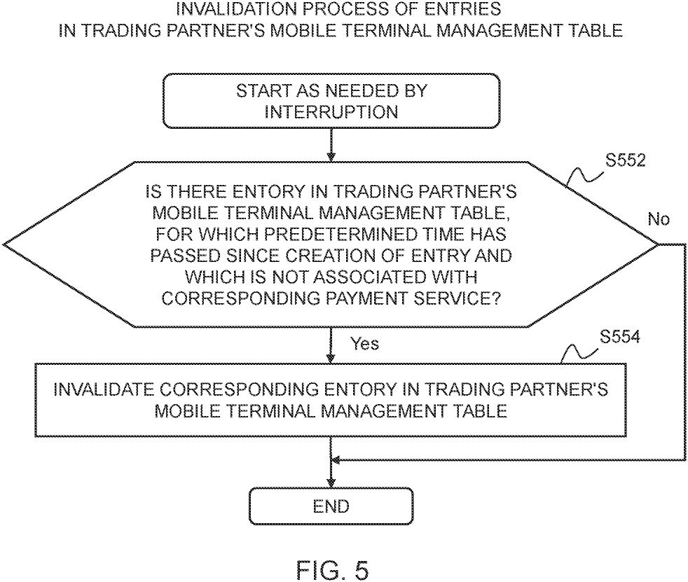

FIG. 5 is a flowchart schematically showing an entry invalidation process of the trading partner’s mobile terminal management table 1600, which is performed by the business operator’s device 106.

Incoming calls to the phone number uniquely allocated to the customer include a call from the trading partner of the customer as well as a call received by mistake and an intentional call made by someone other than the trading partner of the customer. It is not necessary to send a message for a payment service to a caller’s phone number of such calls. Therefore, an entry generated in the trading partner’s mobile terminal management table 1600 by such a call may stay in the trading partner’s mobile terminal management table 1600 for a long time without being used for any payment service.

In order to avoid such a situation, it is preferable that a predetermined period of time is set and entries staying in the trading partner’s mobile terminal management table 1600 for the predetermined period of time or more without being used for any payment service is deleted. This is because such an entry is less likely to be used for such payment service.

If an entry that should not be deleted is accidentally deleted, a call can be made again to the same phone number from the trading partner’s mobile terminal 104.

A specific process flow of FIG. 5 is as follows.

It is preferable that the following process is executed at predetermined intervals by an interrupt process.

[Step S552] It is checked if there is an entry in the trading partner’s mobile terminal management table for which a predetermined time has passed since the entry was created and which is not associated with a corresponding payment service. When the check result is affirmative (Yes), the process proceeds to step S554. If the check result is negative (No), process 140 ends.

[Step S554] The corresponding entry in the trading partner’s mobile terminal management table 1600 is invalidated.

By the above process, unnecessary entries in the trading partner’s mobile terminal management table 1600 can be effectively deleted, and the reliability of payment process can be improved.

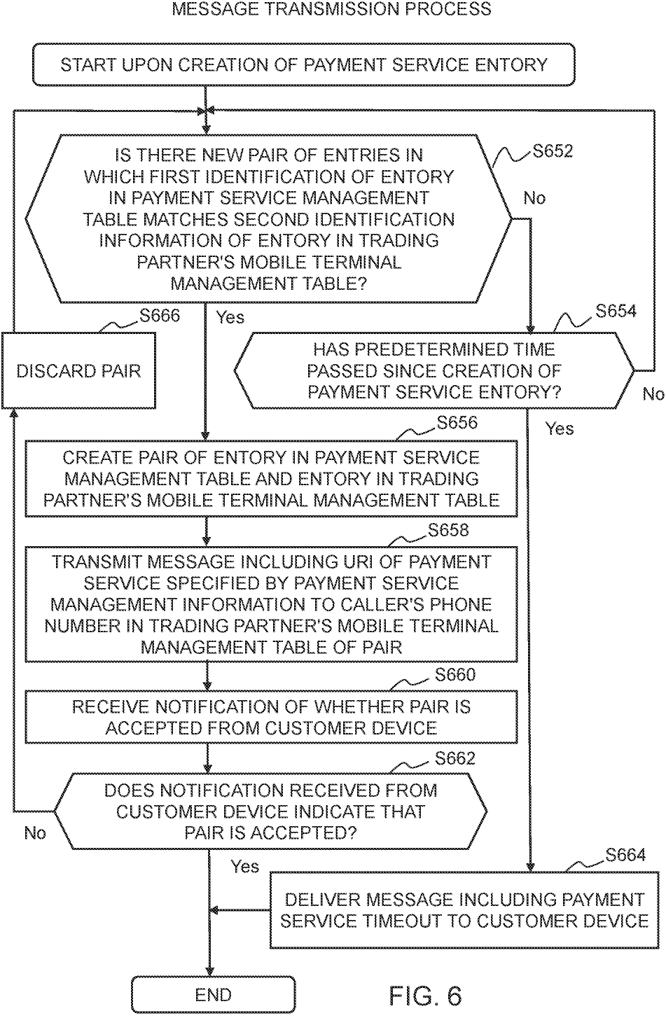

FIG. 6 is a flowchart showing an outline flow of a message transmission process to the trading partner’s mobile terminal, which is performed by the business operator’s device 106. This process is executed by the business operator’s device 106.

It is preferable that this process is started by an event of creating a payment service entry in the payment service management table 1500. It is preferable that this series of processes be started even when a pair of the entry in the payment service management table 1500 and the entry in the trading partner’s mobile terminal management table 1600 is discarded.

[Step S652] It is checked if there is a new pair of entries in which the first identification information of the entry in the payment service management table and the second identification information of the entry in the trading partner’s mobile terminal management table match. Note that re-pairing of entries which have been paired up in the past but whose pair has been discarded is excluded. This is because entries whose pairs have been discarded in the past are entries whose pairs are not acceptable. That is, even when the first identification information and the second identification information match, it has already been determined that it is not appropriate for the trading partner’s mobile terminal 104 for the discarded pair to handle the corresponding payment service. When the check result is affirmative (Yes), the process moves to step S656. When the check result is negative (No), the process proceeds to step S654.

[Step S654] It is checked if a predetermined time has passed since the creation of the entry for the payment service. When the check result is affirmative (Yes), the process proceeds to step S664. When the check result is negative (No), the process returns to step S652.

[Step S656] A pair of an entry in the payment service management table 1500 and an entry in the trading partner’s mobile terminal management table 1600 is created. By creating a pair, the trading partner’s mobile terminal 104 and the payment service are associated with each other. Note that such pair creation can be realized by storing association information in each entry so that the entry in the payment service management table 1500 and the entry in the trading partner’s mobile terminal management table 1600 are associated with each other, for example. The embodiment is not limited to this example.

[Step S658] A message including a URI of the payment service specified by the corresponding entry in the payment service management table 1500 is sent to the caller’s phone number in the paired trading partner’s mobile terminal management table 1600.

[Step S660] A notification is received from the customer device 102 as to whether or not the pair is accepted.

[Step S662] It is checked if the notification received from the customer device is to the effect that the pair is accepted. When the check result is affirmative (Yes), the process ends. When the check result is negative (No), the process proceeds to step S666.

[Step S664] A message containing a timeout of the payment service is transmitted to the customer device 102. In this case, the trading partner’s mobile terminal 104 that handles the payment service cannot be found even after a predetermined period of time has passed since the generation of the payment service. As the cause of such a situation, it is conceivable that an error has occurred in either or both of the first identification information sent by the customer device 102 and the second identification information sent by the trading partner’s mobile terminal 104 when the trading partner’s mobile terminal 104 is making a call to a wrong phone number. In this case, a message containing a timeout is sent to the customer device 102, and the customer device 102 uses other means to enable the trading partner’s mobile terminal 104 to obtain an appropriate URI. As an example of communicating the appropriate URI to the trading partner’s mobile terminal 104, the customer device 102 or the like may display a machine-readable code (for example, a QR code (registered trademark)) containing the appropriate URI, and the trading partner’s mobile terminal 104 may read this QR code (registered trademark). A specific example will be described later.

[Step S666] The pair of the entry in the payment service management table 1500 and the entry in the trading partner’s mobile terminal management table 1600 is discarded. To prevent the discarded pair from becoming a pair again, it is preferable that discarded entries are stored in each of the corresponding entries in the payment service management table 1500 and in the trading partner’s mobile terminal management table 1600, so that the discarded pair can be recognized.

It is preferable that the state (status) of each of the entries of the discarded pair in the payment service management table 1500 and in the trading partner’s mobile terminal management table 1600 is changed so that other pairs can be realized. This changing of the state (status) of the entry will be described in detail later. The process returns to step S652.

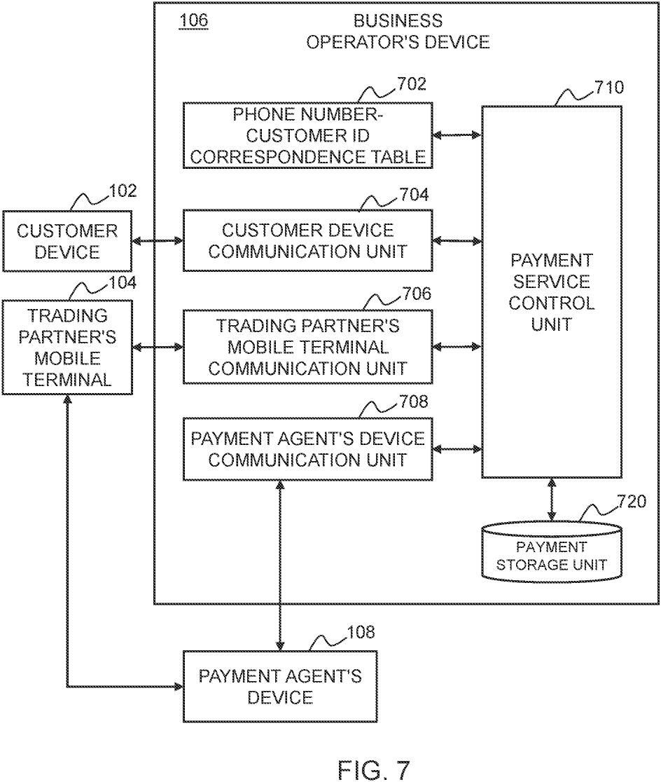

FIG. 7 is a functional block diagram of the business operator’s device 106. The business operator’s device 106 includes a phone number allocation table 702, a customer device communication unit 704, a trading partner’s mobile terminal communication unit 706, a payment agent’s device communication unit 708, a payment service control unit 710, and a payment storage unit 720.

The payment service control unit 710 controls the entire payment service in the business operator’s device 106.

FIG. 14 shows an example of the phone number allocation table 702. The phone number allocation table 702 has entries that store phone numbers uniquely allocated to each of a plurality of customers in association with customer IDs. For example, it is assumed that a call addressed to a phone number 099-1234-1234 is received from the trading partner’s mobile terminal 104. By searching through the phone number allocation table 702 for the phone number 099-1234-1234 and obtaining A12 as the customer ID, it can be specified that the customer ID of the customer who is billing the trading partner is A12.

Referring back to FIG. 7, the customer device communication unit 704 communicates with the customer device 102 and passes the content of the communication to the payment service control unit 710. Based on an instruction from the payment service control unit 710, the customer device communication unit 704 also transmits management information of the payment service, a process result of the payment service, and the like to the customer device 102.

The trading partner’s mobile terminal communication unit 706 communicates with the trading partner’s mobile terminal 104 and passes the content of the communication to the payment service control unit 710. Based on an instruction from the payment service control unit 710, the trading partner’s mobile terminal communication unit 706 also transmits a message including a URI for the payment service to the trading partner’s mobile terminal 104.

The payment agent’s device communication unit 708 transmits to the payment agent’s device 108 billing information from the customer to the trading partner, management information related to payment services, and the like. Also, the communication from the trading partner’s mobile terminal 104 to the business operator’s device 106 can be redirected to the payment agent’s device 108.

Note that the payment agent’s device 108 may be connected to a credit card company’s device or a cashless payment agent’s device.

The payment storage unit 720 can store the payment service management table 1500 and trading partner’s mobile terminal management table 1600 described above, and can store the billing information, the management information related to payment services, the customer device 102, the trading partner’s mobile terminal 104, and the like in association with each other.

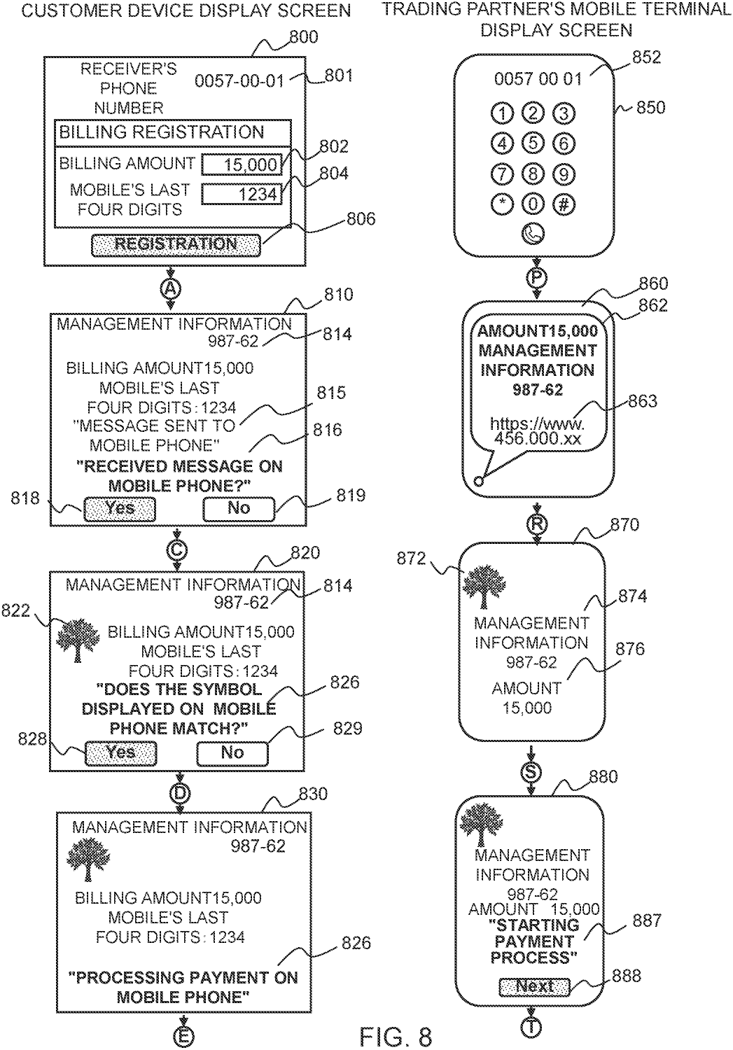

FIGS. 8 to 13 are diagrams showing examples of a display screen displayed on the customer device 102 by the business operator’s device 106 and a display screen displayed on the trading partner’s mobile terminal 104 by the business operator’s device 106. These are schematically drawn in chronological order from top to bottom. It should be noted that the times displayed on the display screens of the customer device and the trading partner’s mobile terminal, which are arranged side-by-side, are approximately the same. The contents displayed on the screens and the display timing are not limited to these examples. A to E and P to T described in the screen transition arrows are for easier understanding of the correspondence between the screen transition arrows in the drawings. Note that the screen transition is merely an example, and the contents and order thereof can be changed as long as there is no discrepancy. Also, it should be noted that it is not essential that all screens are displayed as long as there is no discrepancy.

With reference to FIG. 8, the following description is given assuming that the customer device 102 has logged into the business operator’s device 106 by the customer’s operation.

A receiver’s phone number 801 is displayed on a customer device display screen 800. This receiver’s phone number 801 is a phone number allocated to the customer in advance and communicated to the trading partner’s mobile terminal 104 so that the trading partner can make a call thereto.

Specifically, the phone number is 0057-00-01 (810). The receiver’s phone number 0057-00-01 is entered by key input by the trading partner on a trading partner’s mobile terminal display screen 850 (852), and thus a call is being made. Note that this receiver’s phone number is allocated to the customer in advance, and therefore may be written on a medium such as paper. In this case, the customer can communicate the receiver’s phone number 801 to the trading partner by presenting the paper medium to the trading partner. The receiver’s phone number 801 may also be communicated to the trading partner by other means.

On the customer device display screen 800, the customer has also entered a billing amount 802 and the last four digits 804 of the trading partner’s mobile terminal 104. The last four digits 804 of the trading partner’s mobile terminal 104 are an example of the first identification information. The second identification information is the last four digits of the caller’s phone number of the trading partner’s mobile terminal 104.

When the customer touches a registration button 806, information including the billing amount 802 and the last four digits of the trading partner’s mobile terminal 104 (that is, the second identification information) reaches the business operator’s device 106.

The customer device display screen 810 displays that management information 814 for this payment service, that is, 987-62 is allocated by the business operator’s device 106. Also, “Message sent to mobile phone” 815 indicating that the message has been sent to the trading partner’s mobile terminal 104 is displayed.

An inquiry message “Received a message on mobile phone?” 816 to the customer is displayed. An “Yes” button 818 and a “No” button 819 prompting the customer to answer are displayed.

A message 862 has arrived and is displayed on the trading partner’s mobile terminal display screen 860. It can be seen that the message 862 contains a specific URI 863 to process the payment service.

Since the customer has been able to confirm the arrival of the message at the trading partner’s mobile terminal 104 carried by the trading partner, the customer touches the “Yes” button 818 to highlight the “Yes” button 818 and the business operator’s device 106 is notified of that the “Yes” button 818 has been touched.

The customer device 102 may prohibit the trading partner’s mobile terminal 104 from accessing the URI 863 until the “Yes” button 818 is touched. Thus, even when the message 862 is sent to another terminal and does not reach the trading partner’s mobile terminal 104, access to the URI 863 from that terminal can be prohibited.

On the customer device display screen 820, a symbol 822 associated with the management information 814 is displayed by the business operator’s device 106.

On the trading partner’s mobile terminal display screen 870, access to the URI is successful, and management information 874 and a symbol 872 corresponding to this management information 874 are displayed.

The customer can confirm that the trading partner’s mobile terminal 104 processes the same payment services as the customer device 102 by confirming that either the symbol 822 or the management information 814 displayed on the customer device display screen 810 matches the symbol 872 or the management information 874 displayed on the trading partner’s mobile terminal display screen 870. By recognizing that the symbols 822 and 872 match, the customer can easily confirm this rather than by confirming that the management information 814 and the management information 874 match.

An inquiry message “Does the symbol displayed on mobile phone match?” 826 may be displayed to the customer. The customer can answer this inquiry by touching either an “Yes” button 828 or a “No” button 829 in response to the inquiry, and can notify the business operator’s device 106 whether or not the trading partner’s mobile terminal 104 processes the same payment service as the customer device 102.

The business operator’s device 106 may prohibit the trading partner’s mobile terminal 104 from proceeding with the payment process until the “Yes” button 828 is touched. This makes it possible to prevent the trading partner’s mobile terminal 104 from processing a wrong (or different) payment service.

The customer device display screen 830 displays a message “Processing payment on mobile phone” 826 indicating that the payment service is in progress on the trading partner’s mobile terminal 104.

The trading partner’s mobile terminal display screen 880 displays a message ″Starting payment process″ 887 indicating that the process will be shifted to the payment service.

When the trading partner touches a “Next” button 888, the business operator’s device 106 transmits information regarding the payment service including the billing amount and management information to the payment agent’s device 108 and also redirects the communication from the trading partner’s mobile terminal 104 to the payment agent’s device 108.

By the above process, the trading partner’s mobile terminal 104 can directly communicate with the payment agent’s device 108. The trading partner’s mobile terminal 104 and the payment agent’s device 108 can securely exchange confidential information such as a credit card number required for payment of the payment service.

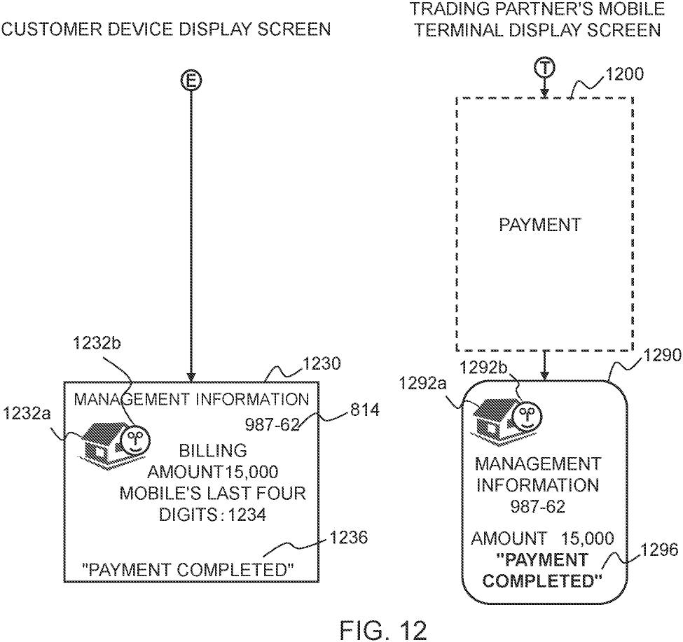

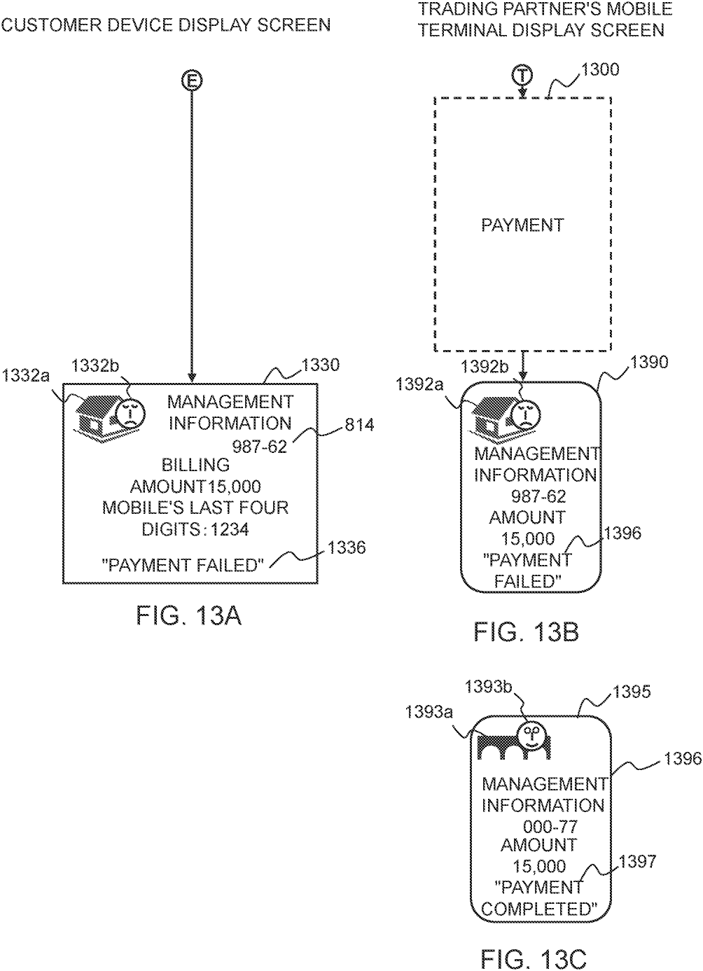

Subsequent processes will be described later with reference to FIGS. 12 and 13.

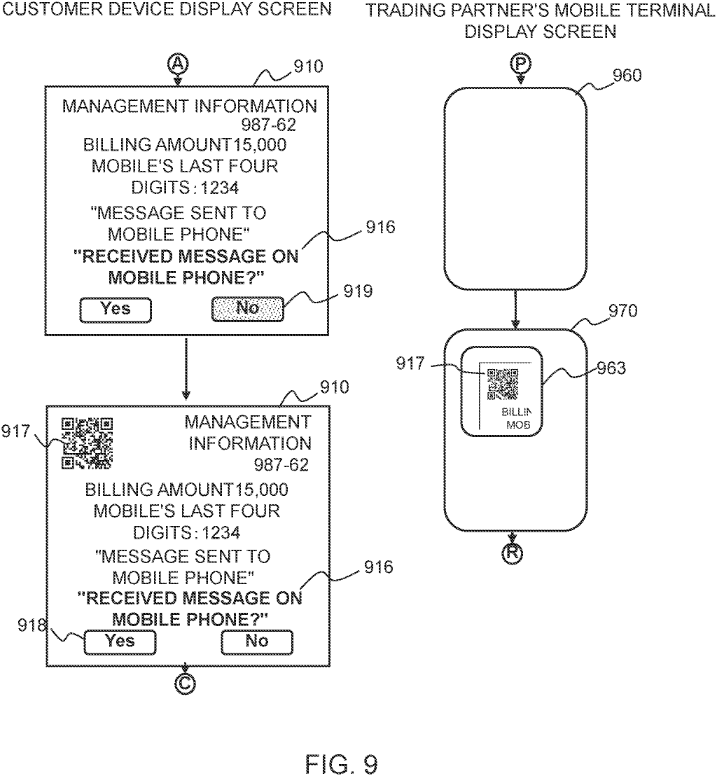

FIG. 9 is an example of a screen after the customer device display screen 800 and the trading partner’s mobile terminal display screen 850 in FIG. 8, showing an example when no message has arrived from the business operator’s device 106.

It can be seen from the trading partner’s mobile terminal display screen 960 that no message has arrived. When no message arrives as in this example, the customer preferably waits for a certain amount of time, for example, one minute. When still no message reaches the trading partner’s mobile terminal 104 within the certain period of time, the customer touches a “No” button 919 in response to the inquiry message “Received a message on mobile phone?” on the customer device display screen 910.

To deal with this situation, the customer device display screen 910 may display a QR code 917 (registered trademark) containing URI information to process the payment service.

The trading partner may have the trading partner’s mobile terminal 104 capture the QR code 917 (registered trademark) and read the information including the URI to process the payment service.

Thus, the payment service process can be carried on even when no message arrives.

Note that the above example is merely an example, and the disclosure is not limited to this example. As the cause of such a situation where no message arrives, it is conceivable that the first identification information or the second identification information contains an error, that the trading partner’s mobile terminal 104 is making a call to a wrong phone number, a message has been sent by mistake to another mobile terminal, and the like. When a message has been sent to another wrong mobile terminal, the pair may be discarded as described with reference to FIG. 6. In this case, the message may arrive by creating a new pair after discarding the old one. Therefore, as described above, it is preferable that the customer waits for a certain period of time even when the message does not arrive.

Also, when it turns out that the trading partner’s mobile terminal 104 has made a call to a wrong phone number, the message may be delivered by calling a correct phone number from the trading partner’s mobile terminal 104.

When the trading partner gives the customer wrong last four digits of the caller’s phone number of the trading partner’s mobile terminal 104, or when the customer enters the wrong last four digits into the customer device 102, the last four digits may be re-entered. Alternatively, the business operator’s device 106 may create a new payment service by invalidating the already generated payment service according to the customer’s instructions and entering correct last four digits and billing amount.

The trading partner’s mobile terminal display screen 970 displays how the QR code 917 (registered trademark) is captured by a camera. The trading partner’s mobile terminal 104 can use the URI for the payment service process, which is contained in the QR code 917 (registered trademark), to shift to the trading partner’s mobile terminal display screen 870 in FIG. 8, for example.

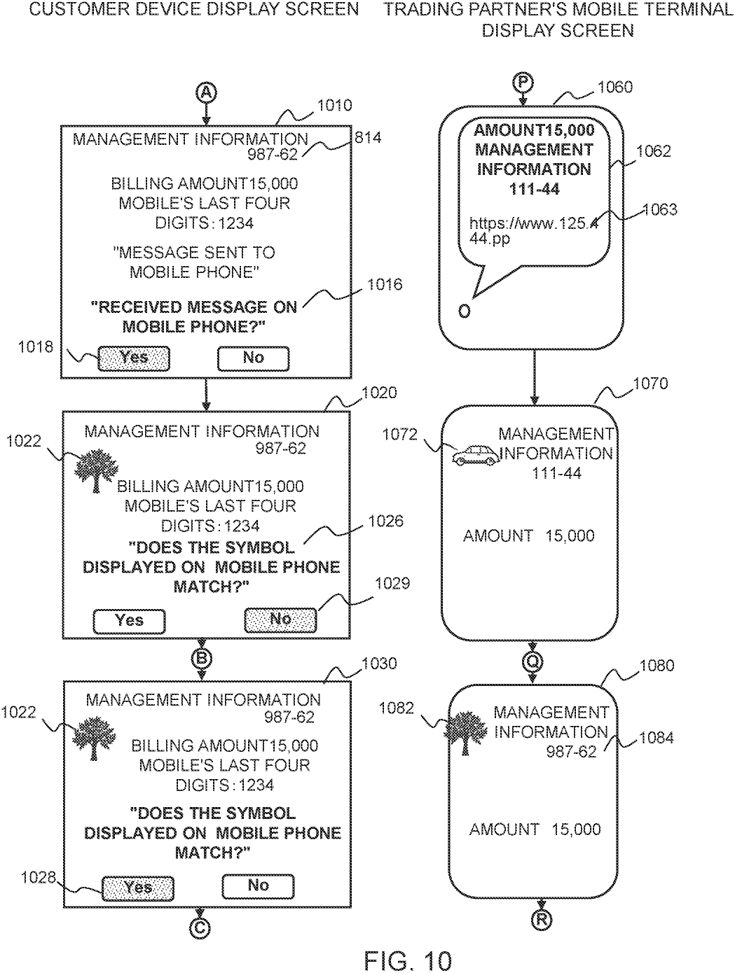

FIG. 10 is a diagram showing an example of screen transition related to handling an exceptional case in which a wrong payment service process URI is sent through a message.

The trading partner’s mobile terminal display screen 1060 displays a message. However, management information in a message 1062 is different from the management information 814 on the customer device display screen 1010.

In this case, since the message is displayed on the trading partner’s mobile terminal display screen 1060, the customer has touched the “Yes” button 1018 by mistake in response to the inquiry message “Received a message on mobile phone?” on the customer device display screen 1010. Such a situation may occur because the customer may not be able to check the management information in the message from the trading partner.

In this case, a symbol 1022 displayed on the customer device display screen 1020 in FIG. 10 is different from the symbol 1072 displayed on the trading partner’s mobile terminal display screen 1070. Therefore, the customer can easily recognize that the trading partner’s mobile terminal 104 is about to start processing a wrong payment service, by checking the symbol displayed on the trading partner’s mobile terminal display screen 1070.

In this case, the customer touches the “No” button in response to an inquiry message “Does the symbol displayed on mobile phone match?” 1026. This situation is an example of the case “No” in step S662 in the flow of FIG. 6. In this case, the pair is discarded. Therefore, it is then checked if there is a new pair in step S652 of FIG. 6.

The customer touches an “Yes” button 1028 when confirming that the symbol 1022 on a customer device display screen 1030 in FIG. 10 matches a symbol 1082 on the trading partner’s mobile terminal display screen 1080. This result is transmitted to the business operator’s device 106.

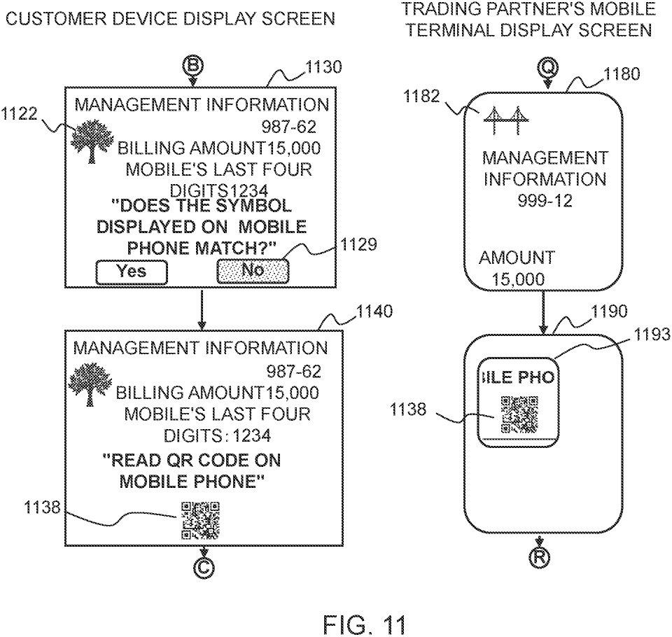

FIG. 11 is a diagram showing an example where matching of the payment service process cannot be confirmed even after a predetermined time has passed.

A symbol 1122 on a customer device display screen 1130 is different from the symbol 1182 on a trading partner’s mobile terminal display screen 1180. Therefore, the customer touches a “No” button 1129. Then, it is assumed that the symbols do not match after a predetermined period of time has passed. This case is a specific example of step S664 in FIG. 6.

In this case, a customer device display screen 1140 may display a QR code 1138 (registered trademark) including a URI. The trading partner may read the QR code 1138 (registered trademark) with a camera of the trading partner’s mobile terminal 104 (1193) as shown on a trading partner’s mobile terminal display screen 1190, thereby reading information including the URI to process the payment service.

Thus, it is ensured that the customer device 102 and the trading partner’s mobile terminal 104 process the same payment service.

FIG. 12 is a diagram showing an example of screen transition when payment is successfully completed. FIG. 12 is a continuation of the process in FIG. 8.

A payment 1200 is being performed on the trading partner’s mobile terminal 104. Here, for example, the trading partner enters a credit card number or the like into the trading partner’s mobile terminal 104. In the payment 1200, the trading partner’s mobile terminal 104 can securely connect with the payment agent’s device 108. Information to be kept confidential, such as credit card numbers communicated in the payment 1200, can be prevented from being transmitted to the customer device 102 and the business operator’s device 106.

Once the payment 1200 is completed, the payment agent’s device 108 transmits the result of the payment to the business operator’s device 106.

In FIG. 12, the business operator’s device 106 causes a customer device display screen 1230 to display “Payment completed” 1236 indicating that the payment has been successfully completed. A symbol 1232a corresponding to the management information 814 for this payment service may also be displayed. A symbol 1232b may also be displayed to indicate that the payment has been successfully completed.

The business operator’s device 106 causes the trading partner’s mobile terminal display screen 1290 to display a display “Payment completed” 1296 indicating that the payment has been successfully completed. Also, a symbol 1292a corresponding to the management information 814 of this payment service may be displayed. A symbol 1292b may also be displayed to indicate that the payment has been successfully completed.

As described above, the customer can easily specify the payment service on the trading partner’s mobile terminal 104 by confirming that the symbol 1292b that is the same as the symbol 1232a corresponding to the management information 814 for the payment service is displayed on the trading partner’s mobile terminal display screen 1290. More specifically, it is possible to confirm that the trading partner’s mobile terminal 104 has processed an appropriate payment service by confirming that the customer device 102 and the trading partner’s mobile terminal 104 are processing the same payment service.

In addition, the customer can easily confirm that the payment has been successfully completed, by checking the symbols 1232b and 1292b indicating that the payment has been successfully completed.

FIG. 13 is a diagram showing an example of screen transition when a payment fails. FIG. 13 is a continuation of the process of FIG. 8. FIG. 13A is a diagram showing an example of a customer device display screen. FIGS. 13B and 13C are diagrams showing examples of a trading partner’s mobile terminal display screen.

After execution of a payment 1300, the payment agent’s device 108 transmits the result of the payment to the business operator’s device 106.

In FIG. 13A, the business operator’s device 106 causes a customer device display screen 1330 to display “Payment failed” 1336 indicating that the payment has failed. A symbol 1332a corresponding to the management information 814 for this payment service may also be displayed. A symbol 1332b may also be displayed to indicate that the payment has failed.

In FIG. 13B, the business operator’s device 106 causes a trading partner’s mobile terminal display screen 1390 to display “Payment failed” 1396 indicating that the payment has failed. A symbol 1392a corresponding to the management information 814 for this payment service may also be displayed. A symbol 1392b may also be displayed to indicate that the payment has failed.

Thus, the customer can easily specify the payment service on the trading partner’s mobile terminal 104 by confirming that the symbol 1392b that is the same as the symbol 1332a corresponding to the management information 814 for the payment service is displayed on the trading partner’s mobile terminal display screen 1390. In addition, by confirming the symbols 1332b and 1392b indicating that the payment has failed, it can be easily confirmed that the payment has failed.

FIG. 13C shows an example of fraud by the trading partner. It is assumed that the trading partner is presenting a trading partner’s mobile terminal display screen 1395 showing the completion of payment in the past, which is stored beforehand in the trading partner’s mobile terminal 104, for example. In this case, the management number 1396 for the payment service is different from the original management number 814 of the customer device 102, and the symbol 1293a corresponding to the payment service management number 1397 is also different from the symbol 1223a. Therefore, the customer can easily recognize that the trading partner’s mobile terminal display screen 1395 displayed on the trading partner’s mobile terminal 104 is a screen based on a different payment service.

In addition, “Payment completed” 1379 indicating the result of payment is displayed, and it is recognized that the symbol 1393b corresponding to the display is the symbol indicating the completion of payment. However, since the symbols 1332a and 1393a are different, the customer can easily recognize that the trading partner’s mobile terminal display screen 1395 is a screen showing the result of a different payment service and is a spoofed screen, thereby preventing fraud.

FIG. 14 is a diagram showing an example of the phone number allocation table 702 for managing receiver’s phone numbers pre-allocated to each customer.

In the phone number allocation table, pre-allocated receiver’s phone numbers are stored corresponding to customer IDs allocated to each customer. This phone number may be written in advance on a medium such as paper by the customer and transmitted to the trading partner of the customer. Alternatively, when the customer device 102 logs into the business operator’s device 106, the phone number may be displayed on the screen of the customer device 102 after the login. When the trading partner enters this phone number into the trading partner’s mobile terminal 104, a call is made from the trading partner’s mobile terminal 104 to the business operator’s device 106. The business operator’s device 106 searches through the phone number allocation table 702 for the received phone number and obtains the customer ID. Thus, the business operator’s device 106 can recognize to which customer the call is made from the trading partner’s mobile terminal 104 of the trading partner. The business operator’s device 106 can manage the trading partner’s mobile terminal 104 with the caller’s phone number and can also send a message including a URI to process the payment service to the caller’s phone number.

FIG. 15 is a diagram showing an example of the payment service management table 1500.

The business operator’s device 106 creates an entry for the payment service in the payment service management table 1500 based on the information including billing and first identification information provided by the customer device 102.

The payment service management table 1500 stores payment process status, first identification information, billing amount, payment service management information, payment service URI, symbol specification information, phone number of the trading partner’s mobile terminal 104 as the caller’s phone number, phone number of the trading partner’s mobile terminal 104 whose pairing has been canceled in the past, and the like. The business operator’s device 106 stores the phone number of the trading partner’s mobile terminal 104 whose pairing has been canceled in the past, thereby avoiding re-pairing the trading partner’s mobile terminal 104 that should not have been paired.

Note that the payment service management table 1500 may store the creation time of each payment service entry.

As for the symbol specification information, one or more symbols may be allocated corresponding to the symbol specification information. As described above, the symbol is information representing the payment service management information (payment results and the like) in a graphic form or the like so that it can be easily identified by humans.

The status information may store the following statuses, for example.
Status 1: Trading partner’s mobile terminal unallocatable (payment service started/completed, unallocated payment service time out, and the like)
Status 2: Trading partner’s mobile terminal allocatable (possible reallocation of trading partner’s mobile terminal since payment service has not yet started)
Status 3: Trading partner’s mobile terminal allocatable (trading partner’s mobile terminal unallocated)

In the case of Status 2, it is preferable to change to Status 3 when the pair is discarded as already described.

FIG. 16 is a diagram showing an example of the trading partner’s mobile terminal management table 1600.

The business operator’s device 106 creates an entry of the trading partner’s mobile terminal 104 in the trading partner’s mobile terminal management table 1600 based on the information including the caller’s phone number and second identification information obtained by an incoming call from the trading partner’s mobile terminal 104.

The trading partner’s mobile terminal management table 1600 stores payment process status, incoming call time, caller’s phone number, second identification information, payment service management information, presence/absence of message transmission, payment service management information for which pairing has been canceled in the past, and the like. The business operator’s device 106 can avoid re-pairing a payment service that should not be paired by storing the management information for the payment service for which pairing has been canceled in the past.

The second identification information may store the last four digits of the caller’s phone number, for example. The second identification information is not limited to the above example.

The status information may store the following statuses, for example.
Status 1: Payment service unallocatable (payment service started/completed, unallocated payment service timeout, and the like)
Status 2: Payment service allocatable (possible reallocation of payment service since payment service has not yet started)
Status 3: Payment service allocable (payment service unallocated)

In the case of Status 2, it is preferable to change to Status 3 when the pair is discarded as already described.

### Example of Information That Can Be Used as Identification information

(1) Part or all of the phone number of the trading partner’s mobile terminal 104 is used as the identification information.

This point has been described in the above embodiment. When the customer does not handle multiple payment services concurrently, part of the phone number of the trading partner’s mobile terminal 104 (for example, the last four digits of the phone number) can also be used as the identification information. The probability that the last four digits of the caller’s phone number of a call from a third party, which is accidentally or intentionally made to the phone number uniquely allocated to the customer, match the last four digits of the phone number of the trading partner’s mobile terminal 104 is about 1/10,000. Therefore, the identification information can be determined to be sufficiently practical. The larger the number of digits in the phone number, the lower the probability of such errors. When the phone number of the trading partner’s mobile terminal 104 is used as the identification information, the probability of such an error occurring is reduced. As an example of ensuring the certainty to prevent such errors, it is possible to avoid such errors easily and reliably by displaying management information and payment results on a screen with characters or symbol images as described above.

The ensuring of the certainty described above can be similarly applied to the following examples.

The management information uniquely allocated to each payment service is used as the identification information.

In this case, information uniquely allocated to each payment service can be used as the identification information. Therefore, in principle, the trading partner’s mobile terminal 104 will not process a wrong payment service. However, an input error of management information may occur. In this case, it is preferable to ensure the certainty as in the above example.

In the above example (2), the management information is transmitted from the business operator’s device 106 to the customer device 102. Thus, the customer can save the trouble of inputting the identification information (that is, the management information) into the customer device 102. The customer device 102 can also omit transmission of the identification information to the business operator’s device 106.

The customer transmits the management information to the trading partner, and the trading partner inputs the identification information (that is, the management number) by key input or the like according to IVR’s instructions or the like after making a phone call. In this case, the trading partner’s time and effort may increase, but the certainty can be easily ensured as long as the input contents are accurate.

Note that a string generated by the business operator’s device 106 may be transmitted to the customer device 102 and used as the identification information. This string may be different from the management information to specify the payment service. This string may be displayed on the customer device 102 and may be entered into the trading partner’s mobile terminal 104 by the customer through key input. Information for managing the payment service may have a large number of digits. Therefore, the business operator’s device 106 may generate a string having a length suitable for the identification information and transmit the generated string to the customer device 102. Alternatively, the business operator’s device may send a string to the customer device for each digit, the customer may transmit the string to the trading partner, and the trading partner may send the string information to the business operator’s device 106 by key input. The length of the string to be confirmed can be reduced by creating a unique string that does not overlap for a predetermined period of time. Alternatively, part of the management information for the payment service may be used as the identification information.

(3) A random string freely selected by the customer or the trading partner is used as the identification information.

In this case, the identification information coincidentally matches with a fixed probability between different payment services. Therefore, it is preferable to ensure the certainty as in the above example. Note that when strings are passed along orally between the customer and the trading partner, it is preferable to use numbers rather than alphabets. This is because alphabets are more likely to be misheard than numbers.

Note that this string may be generated by the customer device 102 or the trading partner’s mobile terminal 104.

(4) A plurality of pieces of the information described above are combined and used as the identification information.

Combining information increases the uniqueness of the identification information. On the other hand, since the number of digits of the identification information increases, the effort of inputting the identification information increases, which may sacrifice convenience. Moreover, when the identification information is communicated orally, the probability of an error occurring during communication increases.

### Method for Transmitting Identification Information

When the identification information is shared orally, the information may be misheard. However, it is a simple operation because the operator can listen and input by operating the keys. Therefore, there is an advantage that the trouble of starting an application (for example, software to read a QR code (registered trademark) or the like) can be saved.

On the other hand, when sharing the identification information by reading a QR code (registered trademark) or using a network or near field communication, the identification information can be shared more reliably. However, when starting an application, starting the application may be complicated. Therefore, when priority is given to a simple and easy UI, it is preferable to enter the orally communicated identification information by key input. On the other hand, when the focus is on reliably sharing the identification information, electronic means may be used to share the identification information.

In the above embodiment, symbols are used to make it easier for humans to confirm matching of the management information and the like. However, other embodiments with no use of symbols can also be adopted. For example, matching between the payment service on the customer device 102 and the payment service on the trading partner’s mobile terminal 104 may be confirmed by making it possible to confirm through the business operator’s device 106 that communication such as a voice call and chat has been successful between the customer device 102 and the trading partner’s mobile terminal 104.

The payment service in the above embodiment is an example of a payment process. The customer device is an example of a device managed by a customer. The trading partner’s mobile terminal is an example of a mobile terminal managed by a trading partner.

While several embodiments of the invention were described in the foregoing detailed description, those skilled in the art may make modifications and alterations to these embodiments without departing from the scope and spirit of the invention. Accordingly, the foregoing description is intended to be illustrative rather than restrictive.

1. A method for intermediating a billing payment process for a trading partner of a customer from the customer, wherein a phone number uniquely allocated to the customer is prepared, comprising:
receiving information about billing associated with first identification information for identifying the billing from a device managed by the customer;
specifying a payment process from information including the first identification information and the billing information; and
transmitting, to the device managed by the customer and a mobile terminal managed by the trading partner, a message related to the payment process based on a comparison result between the first identification information and second identification information delivered in communication addressed to the phone number from the mobile terminal managed by the trading partner, wherein
the step of transmitting a message related to the payment process includes:
transmitting a message including a URI to handle the payment process to a caller’s phone number of the communication, to allow the mobile terminal managed by the trading partner to handle the payment process, based on the comparison result,
providing information about the payment process to a system that executes the payment process,
receiving, from the system that executes the payment process, a result of the payment process performed between the mobile terminal managed by the trading partner and the system that executes the payment process, and
delivering a message of the result of the payment process to at least the device managed by the customer.

2. The method for intermediating payment, according to claim 1, wherein
the first identification information includes part of the caller’s phone number.

3. The method for intermediating payment, according to claim 1, wherein
the first identification information includes a first string specified by the customer or the trading partner.

4. The method for intermediating payment, according to claim 1, wherein
the first identification information includes a second string generated by the device managed by the customer.

5. The method for intermediating payment, according to claim 1, further comprising:
transmitting a third string to the device managed by the customer, wherein the first identification information includes the third string.

6. The method for intermediating payment, according to claim 1, wherein
the message is transferred by any one of SMS, RCS, and MMS.

7. The method for intermediating payment, according to claim 1, wherein
the communication is a voice call or message communication by SMS, RCS or MMS.

8. The method for intermediating payment, according to claim 1, wherein
the providing information about the payment process to the system that executes the payment process includes:
providing information about the payment process to the system that executes the payment process upon receiving an instruction from the device managed by the customer.

9. The method for intermediating payment, according to claim 1, further comprising:
transmitting information for identifying the payment process to at least one of the device managed by the customer and the mobile terminal managed by the trading partner to be seen that the payment process handled by the device managed by the customer is the same payment process as the payment process handled by the mobile terminal managed by the trading partner.

10. The method for intermediating payment, according to claim 9, wherein
the information for identifying the payment process is symbol information allocated to the payment process.

11. The method for intermediating payment, according to claim 10 wherein
the symbol information includes second symbol information or third symbol information, which are different depending on the result of the payment process, whether the payment process is completed or ends incomplete.

12. A non-transitory storage medium storing a program causing a computer to execute the method for intermediating payment, according to claim 1.
